(19) United States
(12) Patent Application Publication
(10) Pub. No.: US 2026/0199724 A1
(43) Pub. Date: Jul. 16, 2026

(54) BATTERY FIRE SUPPRESSION SYSTEM

(71) Applicant: Fike Corporation, Blue Springs, MO (US)

(72) Inventors: Bruce Corry Giffin, Grain Valley, MO (US); Devang Patel, Bedfordshire (GB); Bradford T. Stilwell, Blue Springs, MO (US); Tom Farrell, Lawrence, KS (US); Jordan David Elmer, Olathe, KS (US)

(21) Appl. No.: 19/449,734

(22) Filed: Jan. 15, 2026

Related U.S. Application Data
(60) Provisional application No. 63/746,019, filed on Jan. 16, 2025.

(51) Int. Cl. A62C 35/68; A62C 3/16; F16K 31/122; H01M 50/673

(52) U.S. Cl. CPC A62C 35/68; A62C 3/16; F16K 31/1221; H01M 50/673

(57) ABSTRACT

A fire suppression system is provided comprising an actuator operable to initiate opening of a control valve coupled to a source of a fire suppressant. The fire suppression system is particularly suited for suppressing a fire or thermal event associated with a lithium-ion battery.

### CROSS-REFERENCE TO RELATED APPLICATION

This application claims the benefit of U.S. Provisional Patent Application No. 63/746,019, filed January 16, 2025, which is incorporated by reference herein in its entirety.

### BACKGROUND OF THE INVENTION

Embodiments of the present invention are directed toward systems and their use in controlling thermal events in batteries, especially the suppressing and extinguishing of fires in lithium-ion batteries.

### SUMMARY OF THE INVENTION

According to one embodiment of the present invention there is provided an actuator for operation of a fire suppressant release valve. The actuator comprises an actuator body defining a cavity. A piston is received within the cavity and shiftable between an actuated position and an unactuated position. The actuator includes an inlet port configured to introduce a pressurized gas into the actuator. A passage is connected to the inlet port having a constriction located therein for choking the flow of fluid through the passage, the passage communicating with the cavity. A passageway is laterally disposed from the cavity and configured to conduct the pressurized gas from the cavity toward an actuator discharge port. The actuator includes a relief port that communicates with the cavity but does not communicate with the passage or the passageway. The actuator comprises a spring that biases the piston toward the actuated position.

According to another embodiment there is provided a fire suppression system comprising an actuator as described herein, a source of a pressurized gas, a source of a fire suppressant, a piping network terminating in one or more fire suppressant discharge nozzles, and a valve operable to control the flow of the fire suppressant from the source of the fire suppressant into the piping network.

According to still a further embodiment there is provided a method of suppressing a fire or thermal event within a battery module. The method comprises preloading a piping network with a pressurized gas that is delivered into the piping network through an actuator as described herein. A source of a fire suppressant is provided and coupled to a control valve that is also connected to the piping network. Detection of a fire or thermal event within the battery module causes the pressurized gas contained within the piping network to be released resulting in an attendant drop in pressure within the piping network. This drop in pressure causes the piston located within the actuator to shift to an actuated position in which fire suppressant flows through the actuator and into conduit connected to the valve thereby causing the valve to open and fire suppressant to flow from the source of fire suppressant into the piping network. The fire suppressant is discharged into the battery module suffering the fire or thermal event.

### BRIEF DESCRIPTION OF THE DRAWINGS

FIG. 1 is a perspective view of an actuator for a fire suppression system;

FIG. 2 is a cross-sectional view of the actuator of FIG. 1;

FIG. 3 is a cross-sectional view of a valve that is configured to be connected to a source of fire suppressant and to which the actuator of FIG. 1 is connected;

FIG. 4 is a cross-sectional view of the valve-actuator assembly;

FIG. 5 is a perspective view of a sprinkler head that can be used to deliver the fire suppressant to a battery;

FIG. 6 is a cross-sectional view of the sprinkler head of FIG. 5;

FIG. 7 is a cross-sectional view of another embodiment of a sprinkler head that can be used to deliver the fire suppressant to a battery; and

FIG. 8 is a schematic illustration of a system for actuating

While the drawings do not necessarily provide exact dimensions or tolerances for the illustrated components or structures, the drawings are to scale with respect to the relationships between the components of the structures illustrated in the drawings.

### DETAILED DESCRIPTION OF THE PREFERRED EMBODIMENT

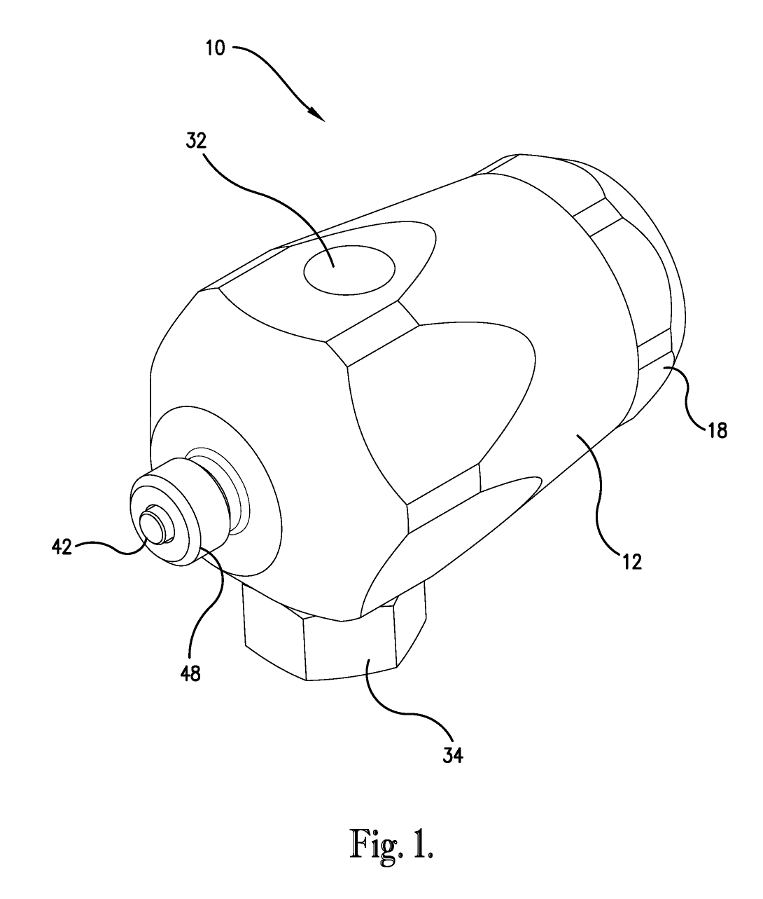

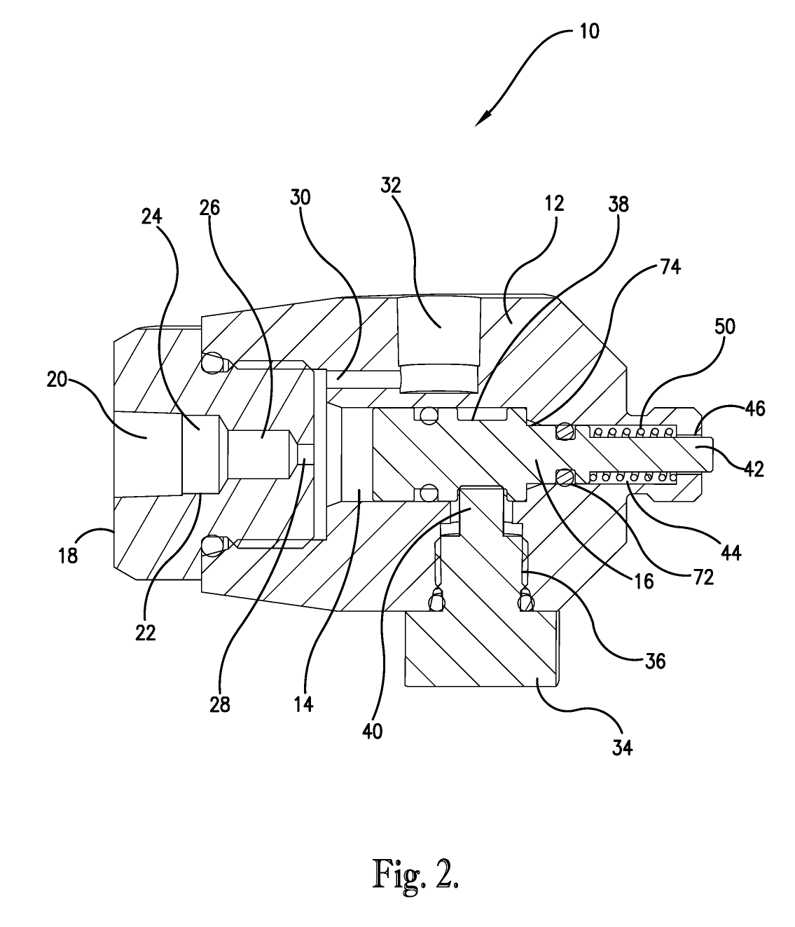

Turning to FIGS. 1 and 2, an actuator 10 is depicted. Actuator 10 is configured to initiate opening of a valve secured to a source of fire suppressant upon detection of a fire condition within a protected space. Exemplary fire suppressants that may be used with the present invention include water, various clean agents such as FK-5-1-12, and those that are described in U.S. Patent Application Publication No. 2025/0046885 (Application No. 18/795,519, filed August 6, 2024), which is incorporated by reference herein in its entirety.

In particular embodiments, the fire suppressing agent is an aqueous or water-containing material comprising, consisting of, or consisting essentially of a carboxylate salt, particularly a C2-C6 carboxylate salt. In particular embodiments, the C2-C6 carboxylate salt comprises a lactic acid salt, an acetic acid salt, citric acid salt, a glycolic acid salt, a butyric acid salt, or a tartaric acid salt. In preferred embodiments, the C2-C6 carboxylate salt comprises a potassium or sodium lactate, acetate, citrate, glycollate, hydroxybutyrate, or tartrate, with potassium lactate being particularly preferred.

In one or more embodiments, the fire suppressing agent comprises, consists of, or consists essentially of from 30% to 80% by weight, 35% to 75% by weight, 40% to 70% by weight, or 45% to 65% by weight, and most preferably about 60% by weight of the carboxylate salt dispersed in water. Accordingly, the water component can make up from 20% to 70% by weight, from 25% to 65% by weight, from 30% to 60% by weight, from 35% to 55% by weight, or about 40% by weight of the fire suppressing agent.

The fire suppressing agent may further comprise, consist of, or consist essentially of one or more optional components that impart beneficial characteristics to the agent. These optional components include an anti-hydrofluoric acid agent and a colorant. In one or more embodiments, the anti-hydrofluoric acid agent is a compound or mixture of compounds that in some manner counteracts the harmful effects of fluorine and/or fluorine compounds that can be liberated during a battery thermal event, and in particular a battery fire. Fluorine-containing materials are often associated with batteries, especially the electrolyte used in lithium-ion batteries. In fact, the most commonly used electrolyte for lithium-ion batteries is LiPF₆. As a part of a thermal event, the fluorine-containing electrolyte can react with other components to generate a fluorine-containing gas, such as hydrogen fluoride (HF) (hydrofluoric acid gas). The anti-hydrofluoric acid agent can operate to impede the reactions from which HF is formed, react with HF gas to form less toxic substances, and/or absorb or adsorb HF gas that is generated so that it is not released to the environment surrounding the battery.

Exemplary anti-hydrofluoric acid agents that can be used with embodiments of the present invention include one or more members selected from the group consisting of citronella oil (or components thereof including citronellal, citronellol, and geraniol), d-limonene, dipentene, p-cumene, β-pinene, oleic acid, and vitamin E. Citronella oil, or its components, and d-limonene are particularly preferred anti-hydrofluoric acid agents. The fire suppressing agent can contain from 0.01% to 2% by weight, 0.05% to 1.5% by weight, from 0.1% to 1% by weight, from 0.2% to 0.8%, from 0.3% to 0.6% or about 0.475% by weight of the anti-hydrofluoric agent.

The addition of a colorant can change the spectral emissivity (and hence, the absorptivity) of the fire suppressing agent, thereby enhancing the agent's ability to absorb thermal radiation emitting from a battery cell undergoing thermal runaway (and absorb thermal radiation that would otherwise be absorbed by another cell within the battery assembly/module). In certain embodiments, the colorant is a pigment or dye, with dyes being particularly preferred due to their ability to their solubility in water. In one or more embodiments, the fire suppressing agent can contain from 0.01% to 1% by weight, from 0.05% to 0.5% by weight, from 0.1% to 0.25% by weight, or about 0.125% by weight of the colorant.

In one or more embodiments, the colorant absorbs light in the wavelength range of 500 to 750 nm, 550 to 700 nm, or 600 to 650 nm. In particular embodiments, the colorant causes the fire suppressing agent to assume a blue color.

Actuator 10 comprises an actuator body 12 defining an internal cavity 14 inside of which a slidable piston 16 is received. A connector fitting 18 is secured to an open end of the actuator body 12 and provides a port 20 for connecting piping or conduit for supplying a pressurized gas, such as nitrogen or air, to the actuator 10. An axial passage 22 is formed within fitting 18 to direct the pressurized gas introduced into port 20 into the interior of the actuator 10. Passage 22 includes a proximal section 24, a distal section 26, and an orifice 28. The orifice 28 communicates with internal cavity 14. In certain embodiments, a bleed screw (not shown) can be inserted into distal section 26 to provide additional control over the flow of the pressurized gas into cavity 14.

As can be seen, proximal section 24 generally presents an internal diameter that is larger than the internal diameter of distal section 26, which is larger than the internal diameter of orifice 28. This progressive stepping down of the diameter of axial passage 22 provides a restriction of the flow of pressurized gas that is introduced into port 20 as it flows into cavity 14.

Cavity 14 is in fluid communication with a lateral passageway 30 formed in the actuator body 12. Passageway 30 communicates with a discharge port 32, also formed in the actuator body 12. Discharge port 32 can be connected with conduit or piping that terminates in discharge heads through which the fire suppressant is ultimately deployed into a protected space.

Piston 16 is initially held in position by a plug 34, which operates to prevent accidental discharge of fire suppressant during system installation and setup. Plug 34 can be threadedly secured within a relief port 36 until it is desired to arm the system at which time plug 34 is removed. Piston 16 comprises a recessed area 38 formed about an outer surface thereof that is configured to mate with a pin 40 extending from plug 34. The mating of recessed area 38 and pin 40 fixes the position of piston 16 within cavity 14.

Piston 16 also includes a rod section 42 that extends within a chamber 44 and through an opening 46 formed in a cap portion 48 of the actuator body 12. A spring 50 is provided around at least a portion of rod section 42 that exerts a force on piston 16, biasing piston 16 toward an actuated position in which the piston shifts within cavity 14 toward orifice 28.

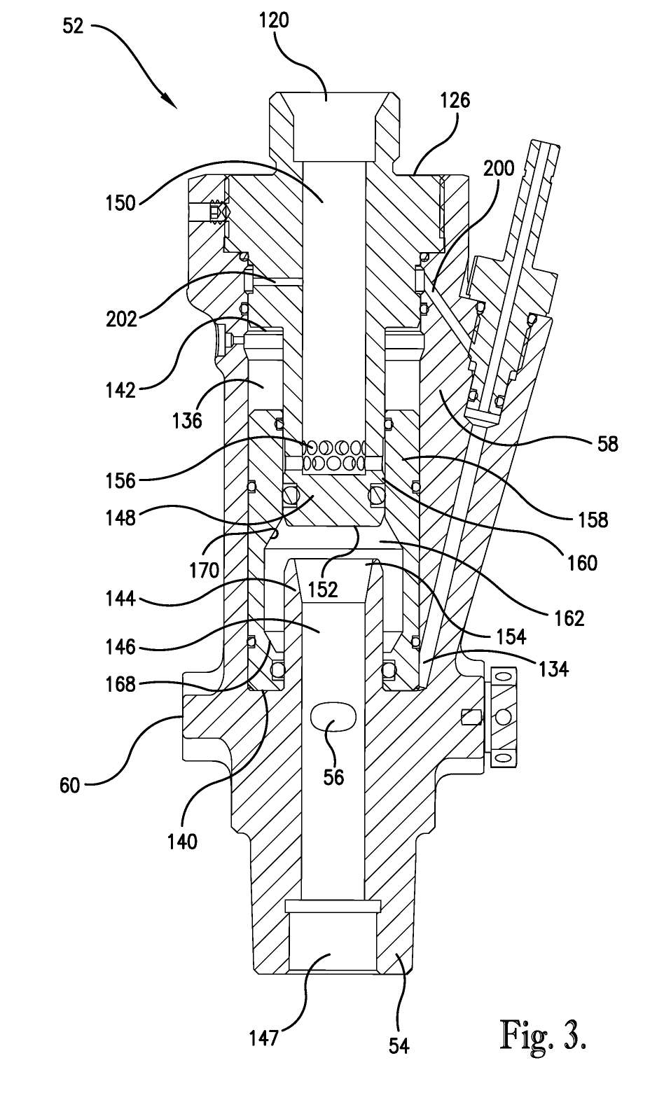

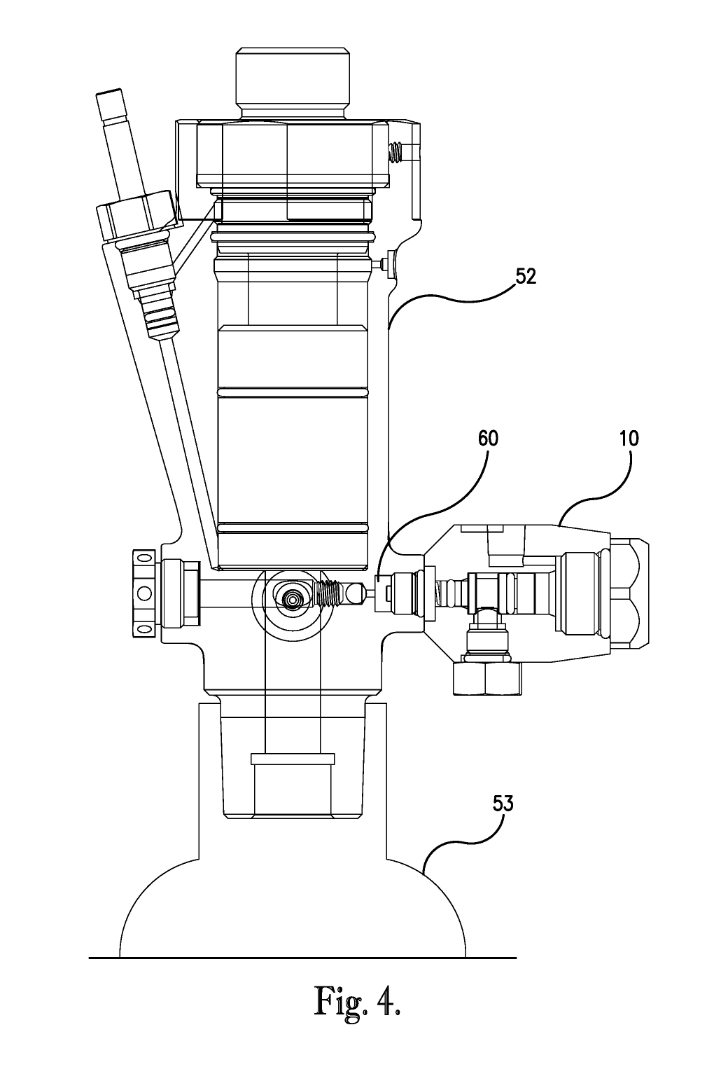

FIG. 3 depicts an embodiment of a valve 52 that can be actuated by actuator 10 as a part of a fire suppression system. Valve 52 is described in detail in U.S. Patent No. 12,038,097, which is incorporated by reference herein in its entirety. However, it is within the scope of the present invention for other types of valves, both actively and passively openable, to be used in fire suppression systems according to the present invention. Valve 52 is attached to a source of a fire suppressant 53, such as a pressurized vessel containing a liquid or gaseous fire suppressant, at connection end 54. FIG. 4 depicts an assembly comprising actuator 10 and valve 52.

Valve 52 includes a channel 56 formed in valve body 58 that communicates with a port 60 into which actuator 10, and particularly the end thereof comprising cap portion 48, is installed. When valve 52 is connected to the source of fire suppressant, the fire suppressant enters channel 56 and flows through opening 46 into chamber 44 where it exerts a force on piston 16 toward the actuated position. However, as explained below, the force of the fire suppressant and spring 50 is normally countered the force exerted on piston 16 by the pressurized gas that enters cavity 14 via orifice 28 to maintain piston 16 in the un-actuated position shown in FIG. 2.

As best seen in FIG. 3 , valve body 58 defines a valve chamber 136. An inlet tubular member 144 that extends into the valve chamber 136. Inlet tubular member comprises an inlet passage 146 that interconnects a valve inlet 147 and the valve chamber 136. In one or more embodiments, an outlet valve section 126 comprises an outlet tubular member 148 that extends into the valve chamber 136 and comprises a selectively closable outlet passage 150 that is configured to conduct a pressurized fluid flowing through the valve 52 toward a valve outlet 120. In one or more embodiments, the outlet tubular member 148 comprises a sealed end 152 that faces the open end 154 of inlet tubular member 144. Outlet tubular member 148 comprises one or more ports 156 that are transverse to the outlet passage 150.

Valve 52 further comprises a shuttle 158 that is located within the valve chamber 136. In one or more embodiments, shuttle 158 is generally cylindrical and comprises a central bore 160 formed therethrough. Shuttle 158 is slidably received over the inlet tubular member 144 and the outer tubular member 148. The shuttle bore 160 defines a shuttle chamber 162, which when the valve 52 is assembled, occupies a portion of valve chamber 136. The shuttle chamber 162 communicates with inlet 147 thereby permitting the pressurized fluid to fill the chamber 162 when the valve 52 is coupled to a vessel or pipework system containing a pressurized fluid as described above.

The shuttle 158 is shiftable, and more particularly slidable, within the valve chamber 136 between a valve closed configuration, as shown in FIG. 35 , and a valve open configuration (not shown). In the valve closed configuration, the shuttle is positioned up against end wall 140 of the valve connector end 54. In this configuration, the shuttle covers ports 156 thereby blocking communication between outlet passage 150 and the shuttle chamber 162. In the valve open configuration, the shuttle is positioned up against end wall 142. In this configuration, ports 156 are now uncovered thereby permitting the flow of pressurized fluid through shuttle chamber 162, through ports 156, and into outlet passage 150.

There are several ways in which the valve 52, and especially shuttle 158, can be configured to hold the shuttle in either the valve open or valve closed configurations. In the embodiment illustrated in FIG. 3, the shuttle chamber 162 comprises interior surfaces 168, 170 upon which the pressurized fluid acts to produce forces upon the shuttle 158 in opposed directions. Particularly, the force acting upon surface 168 biases the shuttle toward the valve closed configuration, while the force acting upon surface 170 biases the shuttle toward the valve open configuration. Note, the surfaces 168, 170 need not be configured to have all or any portion that is perpendicular to the axis along which shuttle 158 slides. Rather, the surfaces need to be configured so that the fluid can exert a force having a force vector that is parallel to the axis along which shuttle 158 slides. In this embodiment, surfaces 168, 170 are substantially equivalent in configuration and area, thus the force acting upon surface 168 is substantially the same as the force acting upon surface 170. Therefore, in this embodiment, the internal forces within the shuttle chamber do not affect shifting of the shuttle 158. Rather, shuttle 158 is influenced primarily by friction forces (between the shuttle 158 and the valve body 58) and gravity, when the valve is installed in a vertical orientation. Accordingly, frictional and gravitational forces operate on shuttle 158 to maintain the shuttle in the valve closed configuration when the valve is installed vertically with the inlet at a lower elevation than the outlet.

In order to provide additional surety that the valve 52 will be maintained in the closed configuration until it is desired to open the valve, the valve can be configured with a biasing element or structure that biases the valve toward the closed configuration.

The valve body 58 also comprises a relief passage 200 that interconnects the actuation fluid passage 134 with the outlet passage 150. In certain embodiments, relief passage 200 may comprise a narrowed segment 202 having a reduced diameter relative to other portions of the relief passage and/or actuation fluid passage 134. It is noted that in certain embodiments of the present invention, the pressure of the actuation fluid introduced into the valve chamber 136 is of a relatively low magnitude compared to the pressure of the fluid located within the shuttle chamber 162. In certain embodiments, the force required to shift the shuttle 158 from the closed to the open configuration is less than 200 psig, less than 100 psig, less than 75 psig, less than 50 psig, less than 30 psig, less than 25 psig, or less than 20 psig. In certain embodiments, the force required to shift the shuttle 158 from the closed to the open configuration is less than 5 times, less than 7 times, less than 10 times, or less than 12 times than the pressure of the fluid being retained on the inlet side of the valve 52. In one or more embodiments, the actuation fluid introduced into the valve chamber 136 via actuation fluid passage 134 has a pressure of from about 5 psig to about 100 psig, from about 10 psig to about 75 psig, or from about 15 psig to about 50 psig.

As a result of the shifting of the shuttle 158 to the valve open configuration, the ports 156 of outlet tubular member 148 are uncovered and the pressurized fire suppression agent contained within the shuttle chamber 162 can flow into outlet passage 150, out of valve outlet 120, and into a pipe network. The fire suppression agent or pressurized fluid is then released into the protected area. In one or more embodiments, a portion of the fluid flowing through outlet passage 150 enters narrowed segment 202, relief passage 200, and actuation fluid passage 134. Thus, these passages form a kind of feedback loop in which the outlet pressure is used to maintain the valve 52 in the open configuration.

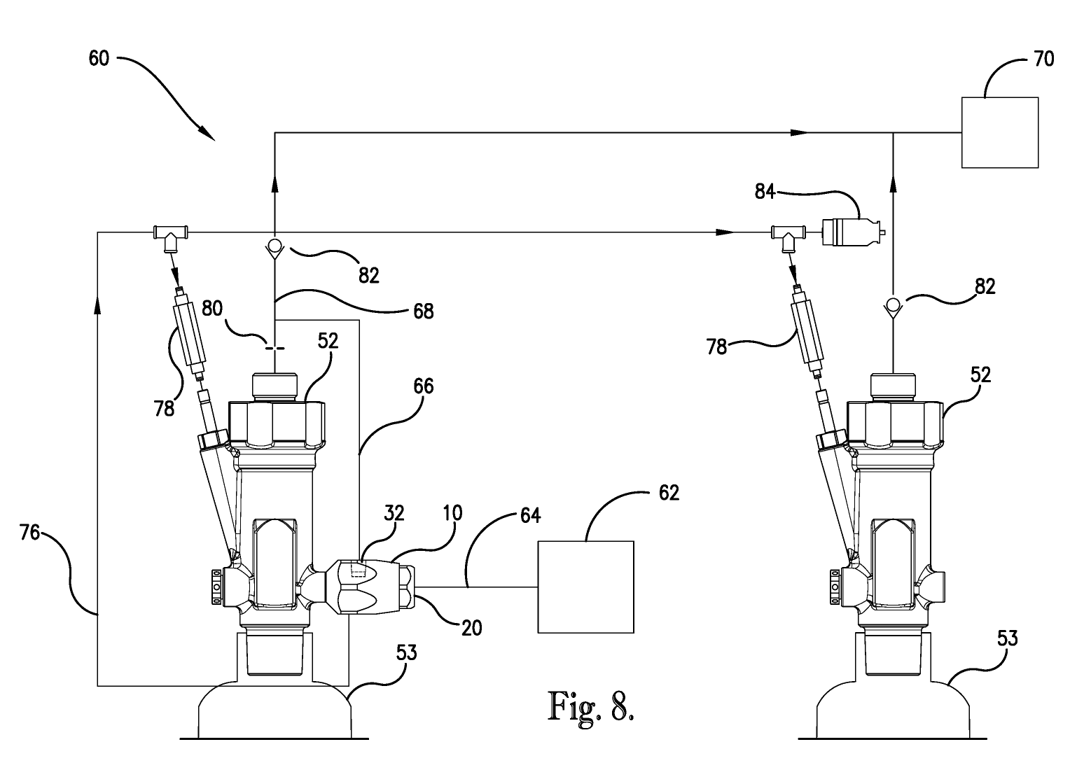

Turning now to FIG. 8, a fire suppression system 60 comprising actuator 10 and a pair of valves 52 is depicted. A source of a pressurized gas 62, such as nitrogen or air, is provided and connected to actuator 10 via line 64. As mentioned previously, the pressurized gas enters actuator 10 through port 20, flows through passage 22 and into cavity 14 where it exerts a force on piston 16. The pressurized gas also flows through passageway 30 and exits the actuator 10 through port 32. The pressurized gas continues to flow through line 66, which intersects with piping 68. Piping 68 terminates in one or more discharge heads 70, which may be installed within or immediately adjacent to a battery module containing a plurality of battery cells (not shown), particularly lithium-ion battery cells. Thus, the piping 68 is pre-loaded with the pressurized gas. In certain embodiments, the pressurized gas from source 62 is provided at a pressure of from 100 to 200 psi, preferably about 175 psi.

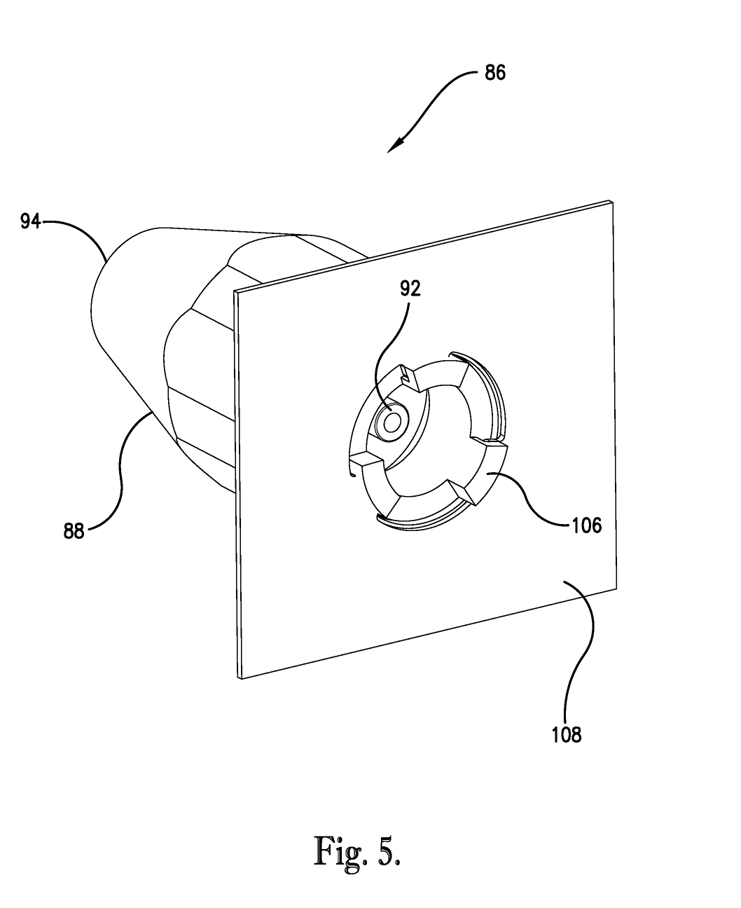

Exemplary heads that may be used with systems 60 are depicted in FIGS. 5-7 and are described in further detail below. Generally, though, preferred heads for use with system 60 comprise a bulb or other actuator that is sensitive to heat conditions that accompany a fire or thermal event. Upon exposure to elevated temperatures, the bulb or actuator breaks, resulting in a release of the pressurized gas contained within piping 68. Orifice 28 and the optional bleed screw choke the flow of pressurized gas through actuator 10. Thus, the pressure within actuator 10, line 66, and piping 68 decreases much faster than it can be replenished from source 62. This decrease in gas pressure results in a decrease in the force exerted on piston 16 toward the un-actuated position (depicted in FIG. 2). The fire suppressant from vessel 53 acting upon piston 16 in conjunction with the biasing force supplied by spring 50 causes the piston 16 to shift within cavity 14 into the actuated position.

In the actuated position, piston 16 is shifted toward orifice 28, which moves seal 72 past chamfered edge 74 of chamber 44. This opens communication between chamber 44 and cavity 14, thereby permitting fire suppressant to flow into and out of relief port 36. The fire suppressant then flows into line 76 where it will be used to open valves 52.

The operation of valve 52 is described in U.S. Patent No. 12,038,097, such description being incorporated by reference herein. The fire suppressant carried in line 76 optionally passes through a check valve 78 (ensuring no backflow of fire suppressant into 76 once valve 52 is opened). Once valve 52 is opened, fire suppressant is introduced into line 68, flowing through an orifice plate 80 and check valve 82.

The purpose of orifice plate 80 is that of a flow restriction device to slow down emptying of the vessel of fire suppressant to which that particular valve 52 is attached. Note, as depicted in FIG. 8, one of valves 52 is equipped with an orifice plate 80, and one is not. Thus, while both of valves 52 will open simultaneously in response to detection of a fire or thermal event, the vessel coupled to the valve containing the orifice plate will empty more slowly than the vessel coupled to the valve that does not contain the orifice plate. It has been discovered that in certain applications, particularly where the fire suppression system is responding to a fire or thermal event involving a lithium-ion battery, it is preferable to deluge the protected space in which the fire or thermal event is transpiring with the fire suppressant in order to flush away as much of the heat involved in the fire or thermal event as possible. Then, a steady and prolonged discharge of fire suppressant from the vessel containing the orifice plate brings the fire or thermal event under control and preferably extinguishes the fire or stops the propagation of the thermal event. For example, the vessel attached to the valve without the orifice plate can be configured to discharge in two minutes or less, while the vessel attached to the valve with the orifice plate can be configured to discharge in 5 minutes, 10 minutes, or more.

Finally, it is noted that a low-pressure vent 84 can be connected to line 76 to prevent opening of valves 52 in response to a slight leak of fire suppressant through actuator 10. Thus, vent 84 assures that discharge of fire suppressant through piping 68 will only occur in response to full opening of actuator 10.

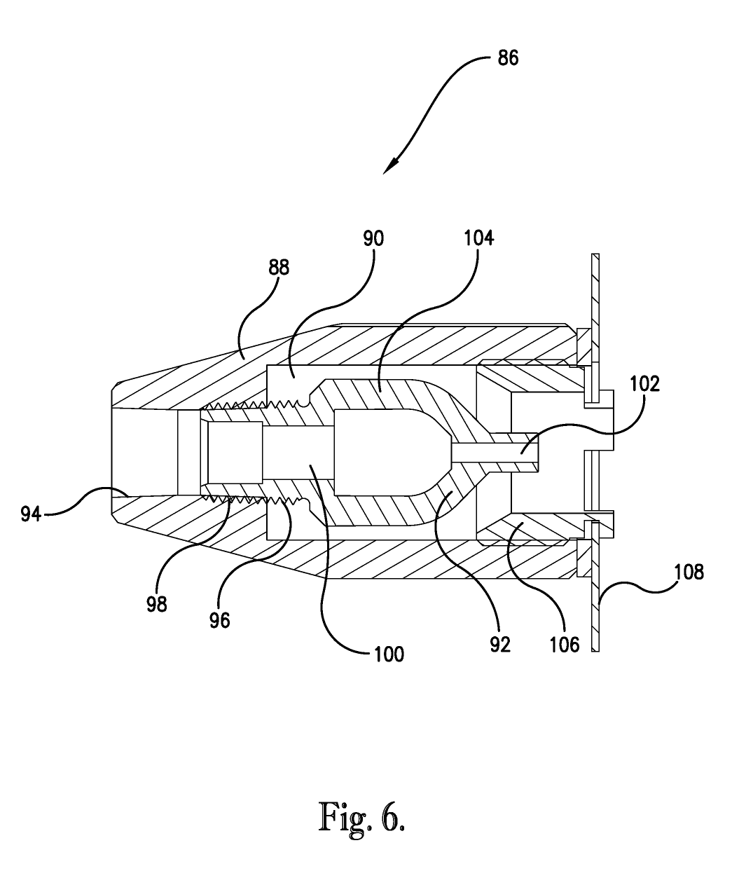

Turning now to FIGS. 5 and 6, an embodiment for a sprinkler head 86 that can be used in fire suppressant systems according to the present invention. In particular, the head 86 depicted comprises a sprinkler body 88 defining a nozzle cavity 90 inside of which a nozzle 92 is located. Sprinkler body 88 includes a coupler section 94 that is configured to be connected to piping 68. Nozzle 92 comprises a threaded section 96 that is configured to mate with a corresponding threaded section 98 of coupler section 94. Nozzle 92 comprises a main passage 100 through which the fire suppressant may flow and a secondary passage 102 that is separated from main passage by arms 104. Normally, a glass bulb (not shown) is disposed in between main passage 100 and second passage 102 to block the flow of fire suppressant therethrough. The bulb is configured to break upon exposure to temperatures exceeding a predetermined threshold. Upon breaking, the bulb is removed from its position blocking passages 100 and 102 thereby permitting fire suppressant to be discharged through nozzle 92.

Sprinkler head 86 further comprises a mounting bracket 106 for affixing head 86 to a wall or panel 108. In certain embodiments, panel 108 comprises a part of a battery container or module, in which there may be very little clearance for a nozzle to protrude. As nozzle 92 is located entirely within nozzle cavity 90, sprinkler head 86 can be located nearly entirely external to the battery module yet still deliver fire suppressant into the interior of the module in response to a thermal event or fire.

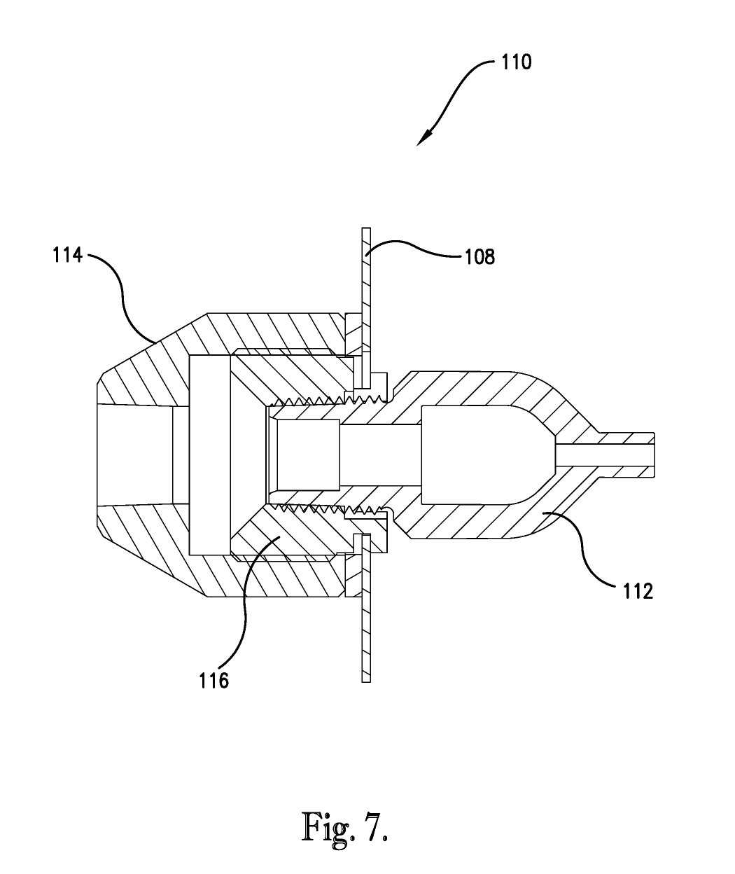

FIG. 7 depicts an alternate embodiment for a sprinkler head 110 that comprises a nozzle 112 configured to extend beyond sprinkler body 114 and into the space behind panel 108, such as the interior of a battery module. In contrast to the sprinkler head 86 depicted in FIG. 6, nozzle 112 is threadedly received within a mounting bracket 116 and is not directly attached to the sprinkler body 114.

It is noted that other types of sprinkler heads may be used with embodiments according to the present invention, including pendent, upright, sidewall, and concealed. The sprinkler heads may be entirely passive employing a glass bulb or fusible link that activate at a predetermined temperature. The sprinkler heads may also be active, such as an electrically operated sprinkler that is actuated based upon input from a sensor located within the protected space.

We claim:

1. An actuator for operation of a valve comprising:
an actuator body defining a cavity;
a piston received within the cavity and shiftable between an actuated position and an unactuated position;
an inlet port configured to introduce a pressurized gas into the actuator;
a passage connected to the inlet port having a constriction located therein for choking the flow of fluid through the passage, the passage communicating with the cavity;
a passageway laterally disposed from the cavity and configured to conduct the pressurized gas from the cavity toward an actuator discharge port;
a relief port that communicates with the cavity, but does not communicate with the passage or the passageway; and
a spring that biases the piston toward the actuated position.

2. The actuator of claim 1, wherein the cavity includes a chamber located opposite of the inlet port, the piston comprising a seal that blocks communication between the chamber and the passage.

3. The actuator of claim 2, wherein when the piston is in the un-actuated position, the piston blocks communication between the chamber and the relief port, and when the piston is in the actuated position, the chamber is in communication with the relief port.

4. The actuator of claim 1, wherein the actuator further comprises a plug that is removably received within the relief port, the plug comprising a pin that extends into a recessed area of the piston, the pin being operable to maintain the piston in the unactuated position.

5. The actuator of claim 2, wherein the piston comprises a major face configured to have a first force exerted on it by the pressurized gas introduced through the inlet port, the first force biasing the piston toward the unactuated position.

6. The actuator of claim 5, wherein the piston further comprises a minor face configured to have a second force exerted on it by a fire suppressant that is introduced into the chamber, the second force biasing the piston toward the actuated position.

7. The actuator of claim 1, wherein at least a portion of the passageway extends parallel to the passage.

8. A fire suppression system comprising:
the actuator according to claim 1;
a source of a pressurized gas;
a source of a fire suppressant;
a piping network terminating in one or more fire suppressant discharge nozzles; and
a valve operable to control the flow of the fire suppressant from the source of the fire suppressant into the piping network.

9. The fire suppression system of claim 8, wherein the one or more fire suppressant discharge nozzles are configured to deliver the fire suppressant into one or more battery modules.

10. The fire suppression system of claim 9, wherein the system further comprises a first conduit connecting the actuator inlet port with the source of pressurized gas, and a second conduit connecting the actuator discharge port with the piping network.

11. The fire suppression system of claim 10, wherein the piping network is initially filled with the pressurized gas, and upon detection of a fire or thermal event within the one or more battery modules, the pressurized gas is released from the piping network, the release of the pressurized gas from the piping network causing the actuator piston to shift to the actuated position which causes the valve to open and fire suppressant to flow from the source of fire suppressant into the piping network.

12. A method of suppressing a fire in a battery module, the method comprises:
providing a source of a fire suppressant within at least two pressurized containers, there being a control valve connected to each pressurized container that controls the flow of fire suppressant out of its respective pressurized container and into a piping network, the piping network being connected to one or more discharge nozzles in communication with the battery module;
pressurizing the piping network with an actuating gas provided by a source of actuating gas, the source of actuating gas being fluidly connected with an actuator through which the actuating gas flows in order to pressurize the piping network, the actuator being fluidly connected to one of the control valves;
initiating a flow of the actuating gas from the piping network in response to a fire hazard within the battery module, the flow of actuating gas causing a decrease in pressure of the actuating gas within the piping network and within the actuator;
the decrease in pressure of the actuating gas within the actuator initiating a flow of fire suppressant through the actuator, the flow of fire suppressant through the actuator causing the control valves to open and initiate a flow of the fire suppressant into the piping network; and
delivering a flow of the fire suppressant from the piping network, through the one or more discharge nozzles and into the battery module.

13. The method of claim 12, wherein a flow restriction device is installed in the piping network downstream of one control valve, the flow restriction device configured to retard the flow of fire suppressant from one of the containers into the piping network.

14. The method of claim 13, wherein there being no flow restriction device installed in the piping netword downstream of the at least one other control valve.

15. The method of claim 14, wherein the method comprises delivering fire suppressant material from the container and into the piping network attached to the control valve having no flow restriction device installed downstream thereof at a higher rate than from the container attached to the control valve having the flow restriction device installed downstream thereof.

16. The method of claim 15, wherein the delivering step comprises delivering an initial flow of fire suppressant into the battery module followed by a secondary flow of fire suppressant into the battery module, the initial flow a higher flow rate and being of a shorter duration than the secondary flow.
